(19) United States
(12) Patent Application Publication
(10) Pub. No.: US 2022/0014812 A1
(43) Pub. Date: Jan. 13, 2022

(54) SYSTEM AND METHOD FOR PROVIDING ENHANCED MULTI-COMPONENT INTEGRATED WEBSITE MEDIA TECHNOLOGY

(71) Applicant: Spring St. Corporation, Coral Cables, FL (US)

(72) Inventors: Les Kocsis, Coral Cables, FL (US); Brian Gibson, Melissa, TX (US)

(73) Assignee: Spring St. Corporation, Coral Cables, FL (US)

(21) Appl. No.: 17/369,172

(22) Filed: Jul. 7, 2021

Related U.S. Application Data
(60) Provisional application No. 63/049,407, filed on Jul. 8, 2020.

(51) Int. Cl. H04N 21/431; G06F 16/957; H04N 21/2743; H04N 21/258

(52) U.S. Cl. CPC H04N 21/431; H04N 21/25808; H04N 21/2743; G06F 16/9577

(57) ABSTRACT

A system for providing enhanced multi-component integrated website media technology is provided. In particular, the system may provide for multi-component web site video technology including options for user controls and enhanced features that may all be contained within a website or software application's existing framework. The system allows for a website page design to be created by combining multiple media players into one seamless website page design. The system enables additional features to be added within the website page design to present and control various media content. The system also allows for cross functionality to exist from one video player to another. The system allows for the creation of multi-component video website page designs, by combining multiple videos into one overall integrated website page design. The system permits multiple videos to be presented in unique combinations, such as tiled video pages, video columns, video boxes/rectangles, video playlists, and other combinations.

### CROSS-REFERENCE TO RELATED APPLICATION

This application claims the benefit of U.S. Provisional Patent Application No. 63/049,407, filed on Jul. 8, 2020, which is incorporated herein in its entirety.

### FIELD OF THE INVENTION

The present application relates to media technologies, streaming technologies, media integration technologies, website technologies, media composing technologies, and more particularly, to a system and method for providing enhanced multi-component integrated website media technology.

### BACKGROUND

In today's technologically-advanced society, various types of technologies exist for providing media content on websites, mobile applications, and other user-accessible technologies. For example, there exist websites that have video functionality provided via a framed-in video player, such as YouTube® and other such similar video players. As another example, there exist websites that use a simple HTML5 video tag within a website page design. Media content, such as video content, can be shown as an element within the page, or as the entire page itself. Notably, however, these video page technology designs only play video within the framed-in video player structure and utilize basic video control functions, such as play, pause and stop. Such video solutions do not present multiple videos playing together within a single unified website design and do not allow for integrated functionality to exist between individual video page design components. Additionally, existing video solutions simply present and play a video without multiple video player designs and do not provide integrated creative design and/or technical functionality between multiple videos playing on the same page. Furthermore, many video solutions present poorly on mobile applications, with videos being played in a smartphone's native player or being played as a simple framed-in box, which lack much of the flexibility and functionality that may exist in a corresponding desktop version.

While current technologies provide for certain benefits and efficiencies, these technologies can be substantially improved and enhanced. In particular, current technologies may be improved so as to provide improved media content experiences, improved media integration capabilities, enhanced user interactions, and improved media control capabilities. Such enhancements and improvements to methodologies and technologies may provide for increased efficiency, increased effectiveness, enhanced media consumption capabilities, improved results, and increased ease-of-use.

### SUMMARY

A system and method for providing enhanced multi-component integrated website media technology is provided. In particular, the system and methods may provide for multi-component website video technology including options for user controls and enhanced features that may all be contained within a website or software application's existing framework. The system and method allow for a website page design to be created by combining multiple media players into one seamless website page design. Additionally, the system and method provide for many additional features to be added within the website page design to present and control various media content. In certain embodiments, the system and method also allow for cross functionality to exist from one video player to another. In certain embodiments, the system and method allow for the creation of multi-component video website page designs, by combining multiple videos (e.g. two videos to an unlimited number) into one overall integrated website page design. These designs permit multiple videos to be presented in unique combinations, such as tiled video pages, video columns, video boxes/rectangles and video playlists, etc. Each unique and custom page design allows for each video to be controlled by the user with specifically custom created video player controls and an overlay copy that is unique to each design. In certain embodiments, all video page design elements may be contained within a single website page design framework.

The foregoing system and method allow for new website video page creative designs and video player functions that have not been possible before. For example, the system and methods facilitate cross functionality and interchangeability between video panels by utilizing multi-tile video pages (e.g. 24-tile video pages), multi-column video pages (e.g. 3-column video page), and/or semi-circular video pages. The system and method do not have the restrictions of framed-in and/or embedded video players. Additionally, the system and method enable page designs to be custom-created to any desired specification. Furthermore, the system and method enable media content to be presented on mobile devices in the same way as on desktop/laptop devices. Notably, the system and method function across all desktop and mobile devices in a similar manner and enable adjustments for smaller screen sizes and devices.

To that end, in an embodiment, a system for providing enhanced multi-component integrated website media technology is disclosed. The system may include a memory that stores instructions and a processor that executes the instructions to perform operations for the system. The system may perform an operation that includes providing a video presentation layer that generates a page framework for each webpage of a website. Additionally, the system may perform an operation that includes providing a video control presentation layer for providing video controls for media content presented on each webpage of the website. Furthermore, the system may perform an operation that includes providing a video actions layer for controlling actions to be performed by a user with regard to the media content.

In another embodiment, a non-transitory medium comprising instructions, which, when loaded and executed by a processor, perform various operations for providing enhanced multi-component integrated website media technology is disclosed. The operations may include: providing, by utilizing instructions from a memory that are executed by a processor, a video presentation layer that generates a page framework for each webpage of a website; providing a video control presentation layer for providing video controls for media content presented on each webpage of the website; and providing a video actions layer for controlling actions to be performed by a user with regard to the media content.

These and other features of the systems and methods for providing enhanced multi-component integrated website media technology are described in the following detailed description, drawings, and appended claims.

### BRIEF DESCRIPTION OF THE DRAWINGS

FIG. 1 is a schematic diagram of a system for providing enhanced multi-component integrated website media technology according to an embodiment of the present disclosure.

FIG. 2 is a screenshot of an output generated by the system of FIG. 1 according to an embodiment of the present disclosure.

FIG. 3 is a screenshot of an output generated by the system of FIG. 1 that includes semi-circular media content displayed in proximity to other media content according to an embodiment of the present disclosure.

FIG. 4 is a screenshot of an output generated by the system of FIG. 1 that includes a media player embedded within a website page according to an embodiment of the present disclosure.

FIG. 5 is a screenshot of an output generated by the system of FIG. 1 that includes a HTML5 video tag design within a website page according to an embodiment of the present disclosure.

FIG. 6 is a screenshot of an output generated by the system of FIG. 1 that includes a multi-tile media content website page according to an embodiment of the present disclosure.

FIG. 7 is a screenshot of an output generated by the system of FIG. 1 that includes a multi-column media content website page according to an embodiment of the present disclosure.

FIG. 8 is a flow diagram illustrating a sample method for providing enhanced multi-component integrated website media technology according to an embodiment of the present disclosure.

### DETAILED DESCRIPTION OF THE DRAWINGS

A system 100 and accompanying methods for providing an integrated website page design that combines multiple videos and user controls into one complete integrated website page with linked video features between the various page video design elements. Specifically, this the system 100 and methods allows for the presentation of fully integrated videos (e.g. one to many) on a webpage with customizable controls without the use of a third-party player or other proprietary code. In certain embodiments, the functionality provided by the system 100 and methods may be based entirely on industry-accepted coding standards and open source languages, which may allow for identical presentation of media content across browsers and devices, as well as allowing for tailored presentation by device type. The system 100 and methods provide a unique and proprietary process, combination, and configuration of native code and open source components, along with the optional use of a content delivery network 130 (CDN) and other speed enhancing features, to present seamless video experiences not achieved by third party players. In addition, the system 100 and methods may be implemented into any new or existing website or website platform for full administrative control over all content and/or videos utilized in the solution.

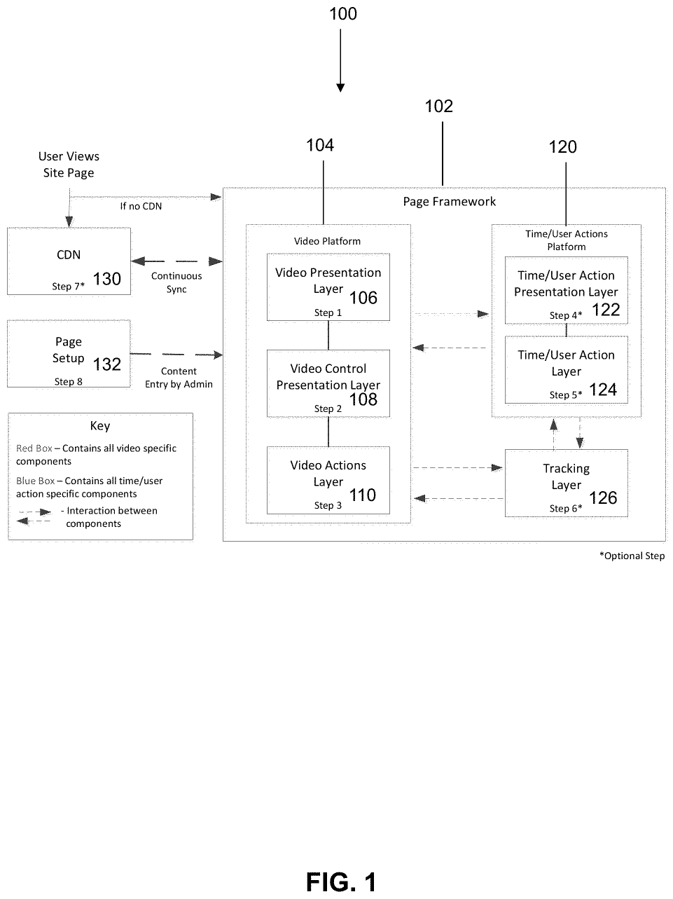

As shown in FIG. 1 and referring also to FIGS. 1-7, a system 100 for providing multi-component integrated website media technology is disclosed. Notably, in certain embodiment, the system 100 may be configured to support, but is not limited to supporting, content delivery services, monitoring services, cloud computing services, satellite services, telephone services, voice-over-internet protocol services (VoIP), software as a service (SaaS) applications, platform as a service (PaaS) applications, gaming applications and services, social media applications and services, operations management applications and services, productivity applications and services, mobile applications and services, and/or any other computing applications and services. In certain embodiments, the system 100 may include and/or incorporate a plurality of features. A first feature may include video tag code (or media tag code). In certain embodiments, HTML5 video tag code may be used in video sections to play videos or other media content. The video tag code may allow for the use of standardized, integrated and consistent video playback functionality across different types of devices. In certain embodiments, the video tag code may utilize a playsinline attribute for running inline videos on mobile devices. In certain embodiments, the video tag code may utilize autoplay and muted attributes for allowing video autoplay on page load. In certain embodiments, the ‘muted’ attribute may be removed for sound enablement. The video tag code may also include a preload attribute that may be set to ‘auto’ to begin a video download on page load for quicker video starts. Additionally, the video tag code may include a loop attribute utilized for looping autoplay videos. In further embodiments, the video tag code may utilize WEBM and MP4 video formats to cover required video formats on all major browsers and on all types of devise.

A second feature of the system 100 may include video control and content code, such as, but not limited to, HTML5-based video controls and content code. In certain embodiments, the video control and content code may provide the foundation for video controls including, but not limited to, play, pause, volume, fullscreen, play bar, and mute. In certain embodiments, HTML5/CSS3 may be utilized to create the layout of a webpage, video sections within the web page, and overlay content. In certain embodiments, controls implements via the video control and content code may be configured to work across browser and device types, and may be tailored for different-sized devices. A third feature of the system 100 may include styling code, such as, but not limited to CSS3 styling code. In certain embodiments, the styling code may be utilized to style the appearance of video controls that are displayed on a webpage. For example, the styling code may style play, pause, volume, fullscreen, play bar, mute, and/or any other controls. In certain embodiments, the system 100 may be utilized the code to create the layout of a page, video sections, and/or overlay content. In certain embodiments, the CSS3 code may be utilized to control all layering and styling aspects. In certain embodiments, on page load, jQuery/CSS3 may be used to set the page layout for video/controls based on a device's type and/or size. The system 100 may also utilize the code to facilitate adaptive presentation of video and/or controls based on device width. In further embodiments, the system 100 may utilize the code to show/hide controls/control pieces based on device width as well.

A fourth feature of the system 100 may include additional control code, such as jQuery control code. On page load, jQuery control code may be utilized to check website (or mobile application) visitors' internet connection speed to serve up the optimal video size and/or resolution for the detected connection speed. In certain embodiments, the control code of the system 100 may account for four distinct ranges of connection speed, including, but not limited to, poor, ok (i.e. satisfactory), good, and excellent internet connection access speeds. In certain embodiments, other ranges and/or classifications for connection speed may be possible. In certain embodiments, the system 100 may serve video for the top three ranges and static images for poorest so as to maintain page load speeds. In certain embodiments, the jQuery may be used to create control code for video actions, such as, but not limited to, play, pause, volume, fullscreen, play bar, mute, and/or other actions. On page load, jQuery/CSS3 may be utilized to set page layout for video/controls based on device type and/or size. In certain embodiments, the control code may facilitate the adaptive presentation of video and/or controls based on device width, and show/hide controls/control pieces based on device width as well. A fifth feature of the system 100 may include utilizing one or more types of video, such as, but not limited to, MP4 and WEBM video. In certain embodiments, the system 100 may convert master video(s) (or other media content) to web-optimized MP4 and WEBM file formats. In certain embodiments, the system 100 may utilize master video formats, including, but not limited to, MOV, WMV, AVI, MP4, WEBM, and other formats. In certain embodiments, the system 100 may enable web file formats to be playable on all major browsers and across device types. The system 100 may also allow for the creation of multiple resolution level versions when determining the optimal playback version for a visitor of a website. In certain embodiments, the resolution level versions may be based on Frames Per Second (typically 30) and resolution (i.e. 1080p, 720p) so as to define the different resolution versions.

A sixth feature of the system 100 may include code for conducting analytics tracking and/or monitoring. The analytics tracking may involve tracking of user interactions with the video (or other media content) on a particular webpage of a website. For example, the analytics tracking may track play, pause, stop, length of play, number of plays, any other interactions with the webpage and/or media content, or a combination thereof. In certain embodiments, the system 100 may utilize a tag manager, such as Google Tag Manager, for tracking and analytics code for presentation purposes. In certain embodiments, the system 100 may include conducting tracking across all browsers and devices that are utilized to access the video and/or other media content on a website or mobile application. A seventh feature of the system 100 may include code for facilitating the performance of time and/or user action-based actions. For example, the system 100 may facilitate the firing of actions outside video (e.g. callout display, sign up form, etc.) based on time in video and/or user video interaction. In certain embodiments, OnHover user actions may be limited to devices with OnHover capabilities. In certain embodiments, jQuery may be utilized to create time/action monitoring and firing mechanisms. In certain embodiments, the system 100, such as via, HTML5/CSS3 may be utilized to create external action presentation pieces. An eighth feature of the system 100 may include use of a CDN 130. The system 100 may utilize domain level CDN to decrease the time and/or distance to a server and thus decrease page load speeds for visitors of a website and/or page. The CDN 130 may also be utilized to decrease the load on the origin server by a distributive network. In certain embodiments, the CDN 130 may be utilized to synchronize between streaming video, JavaScripting & HTML cached media deliveries to provide optimal user experience to visitors of a website (or application). In certain embodiments, the CDN 130 may be utilized to optimize web page content delivery order for the specific viewing browser type and/or device type.

In certain embodiments, the system 100 may include, but is not limited to including: a page framework 102, a video platform 104, a video presentation layer 106, a video control presentation layer 108, a video actions layer 110, a time/user actions platform 122, a time/user action layer 124, a tracking layer 126, a CDN 130, a page setup 132, and/or any other components, devices, processes, and software. The aforementioned components may be utilized for each video page designed and/or constructed by the system 100. To that end, the page framework 102 of the system 100 may include a video platform 104, which may include a plurality of layers. In particular, the video platform 104 may include a video presentation layer 106, a video control presentation layer 108, and a video actions layer 110. The video presentation layer 106 may be utilized to create the framework (e.g. HTML5 framework) for a webpage including video or other media content. In certain embodiments, the video presentation layer 106 may add wCSS3 styling for webpages, including the video area; and add jQuery scripting for webpages, including video file size determination. In certain embodiments, the video presentation layer 106 may be utilized to provide base video player capability and may serve as the base upon which all other layers of the system 100 are built. In certain embodiments, every other component interacts with the video presentation layer 106 at some step. In certain embodiments, the player can function the same across all device types or be custom tailored for a particular device type.

The video control presentation layer 108 may be utilized to create sections (e.g. HTML5 sections) for video controls on a webpage, such as, but not limited to, play, pause, fullscreen, volume, and/or video position bar. The video control presentation layer 108 may add CSS3 styling for the control section and may Add jQuery scripting for the presentation of controls based on a current page state of a webpage. In certain embodiments, the video control presentation layer 108 may provide video player control capabilities. This layer provides the user interface for interacting with and controlling the video. The player controls can be displayed the same across all device types or be custom tailored for a particular device type. The video actions layer 110 may be utilized for conducting and/or controlling actions to be performed with regard to video or other media content. In certain embodiments, the video actions layer 110 may add jQuery scripting for controlling video actions per custom controls. The video actions layer 110 may provide extended video player control capabilities and controls for video and control presentation layers. In certain embodiments, the video actions layer 110 may control all direct interaction between the video control presentation and video presentation layers 106, 108, and as a result of this custom jQuery layer, interactions between the video control presentation layer 108 and video presentation layer 106 can be much more capable and complex than existing solutions. In certain embodiments, the media player controls may function the same or in a similar fashion across all device types or be custom tailored per device type.

The page framework 102 may also include optional components including a time/user actions platform 120, which may include a time/user action presentation layer 122, a time/user action layer 124, and a tracking layer 126. The time/user action presentation layer 122 may be utilized to create sections (e.g. HTML5 sections) for triggered actions (i.e. modal). In certain embodiments, the time/user action presentation layer 122 may add CSS3 styling for the sections. In certain embodiments, the time/user action presentation layer 122 may facilitate and/or provide presentation of content related to time and/or actions taken by a user. The use of HTML5 and CSS3 in the creation of this presentation layer 122 inside a site page allows for endless presentation possibilities. In certain embodiments, the presentation of content has no restrictions, and can be displayed the same across all device types or be custom tailored per device type. The time/user action layer 124 may add jQuery scripting for controlling time/user action-based actions. In certain embodiments, the time/user action layer 124 may provide control capabilities for time and/or user action driven actions. The time/user action layer 124, which may be a custom jQuery based layer, in conjunction with the time and user action presentation layer 122, allows for very finite control of trigger based actions. Each action can function the same across all device types or be custom tailored per device type.

The tracking layer 126 may be utilized to create a manager account and/or script (e.g. Google Tag Manager, Google Analytics, etc.) and may be utilized to add the script to a website and/or application that is providing the media content to visitors. In certain embodiments, the tracking layer 126 may create tag manager account triggers, tags, and/or variables. In certain embodiments, the tracking layer 126 may be configure to provide analytics tracking capabilities through Google Analytics and Google Tag Manager. Tracking may be implemented in each presentation layer, as well as in jQuery-based actions, for a wide range of tracking and reporting options the web site owner can control. As indicated above, the system 100 may include a CDN 130. In certain embodiment, the domain associated with the website may be added to the CDN 130 and/or videos to be displayed on the website may be added to the CDN 130, such as if the video is not domain level video. In certain embodiments, the CDN 130 may provide a distributed server network for added security and speed, such as when presenting web pages to website visitors. In certain embodiments, the system 100 may include a page setup component 132, which may be utilized for content and video loading through existing site administration of the website. In certain embodiments, the page setup component 132 may provide the ability for site administrators of the web site to set content and videos for each video page designed for the website.

Notably, the system 100 may operatively function according to the following use-case scenario. The system 100 may include a website (or application) that contains a plurality of web pages. The web pages may include various types of media content, such as, but not limited to, audio content, video content, streaming content, haptic content, visual content, any other content, or a combination thereof. A user using a computing device may access one or more webpages of the website (or application), such as by utilizing a browser installed on the computing device. Upon the user accessing a webpage of the website (or application), the system 100 may detect the type of computing device that the user is using, the dimensions of the screen of the computing device, a connection speed of an network connection of the computing device, and/or any other information associated with the computing device. For example, the system 100 may detect whether the user is using a desktop computer, a tablet, a smartwatch, a mobile device, and/or any other computing device. Once the type of computing device is detected, the system 100 may customized the experience for the specific type of computing device that the user is using. For example, if the user is using a mobile device, the system 100 may provide media content and other content that is tailored to the mobile device and/or connection speed.

In certain embodiments, the system 100 may perform an auto determination of the video (or other media) file size needed and may auto-play (with looping if desired) on page load of a web page that the user is accessing. In certain embodiments, the system 100 may adapt the media content and web page based on detected internet speed, browser type and/or version, and the device type as well. In certain embodiments, the system 100. In certain embodiments, the system 100 may auto-lay videos and/or other media content, auto-loop the videos and/or other media content. In certain embodiments, the media content may be played with the sound off on initial web page load, such as if browser constraints exist for blocking auto-play of video with sound on. In certain embodiments, the initial sound restriction may apply to all device types, however, upon first interaction with the page by the visitor, the restriction for sound may be removed. An interaction, for example, may mean a mouse click, a hover over a portion of a web page, any input conducted by the user, any action with a keyboard conducted by the user, any command entered by the user, any control exerted by the user, any other interaction or a combination thereof. In certain embodiments, the user may interact with custom controls present on a webpage of the website to restart videos with sound, switch between multiple videos, and control the videos themselves. In certain embodiments, the system 100 may facilitate transition effects per video change, effects that are utilized based on the device type of the user for optimum presentation to the user, actions based on time and/or user actions with the website, and/or analytics tracking of user interactions based on the user actions that occur with the website.

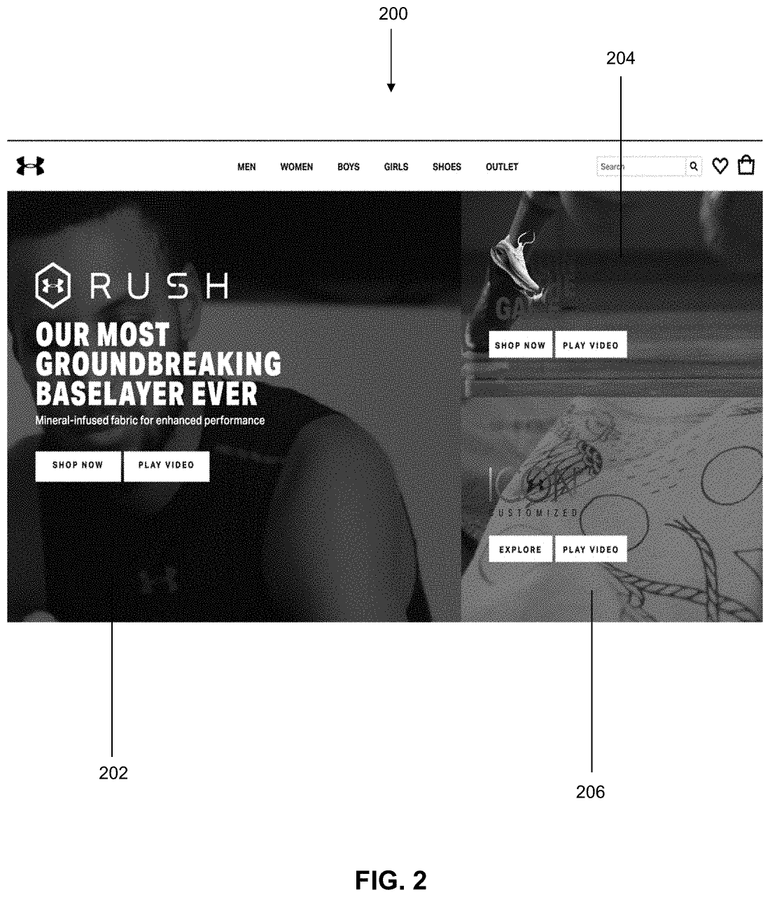

Notably, additional use-case scenarios may also be utilized with the system 100. Referring now also to FIG. 2, an example screenshot of an output 300 generated by the system 100 is shown. The output 200 may be a webpage that may feature multiple videos integrated into a single seamless overall webpage design to the user visiting the webpage of the website. For example, a first video feed 202 is shown on the left of the webpage with its own controls for shopping and playing the video, a second video feed 204 is shown on the top right of the webpage with its own shopping and play video controls, and a third video feed 206 is shown on the bottom right of the webpage with explore and play video controls. The website page design output 200 has three independent videos 202, 204, 206 integrated into one seamless overall page design to the site user. In certain embodiments, each video 202, 204, 206 may play simultaneously with no sound playing initially. In certain embodiments, each video has custom created overlay graphics and user-controlled navigation buttons placed on top of the videos, as shown in FIG. 2. In certain embodiments, when the user clicks on any of Play Video buttons, the corresponding video starts playing from the beginning of the video with sound enabled, and a video player control bar may appear to give the user control over the video to pause the video, mute the video, go into a full screen video mode, and/or perform other interactions with the video. In certain embodiments, at any time, the user can click on another video Play Video button for a different video to enable the different video, with the same control features, as described above. In certain embodiments, the user can also click on any of the other digital buttons to navigate to secondary website pages of the website. In further embodiments, the design for the webpages utilized by the system 100 may modified for mobile adaptive use for mobile devices to provide the same user experience as on larger laptop/desktop screens and adjusted for a smaller screen. For example, the videos may be stacked on top of each other, instead of being placed across a wider large screen.

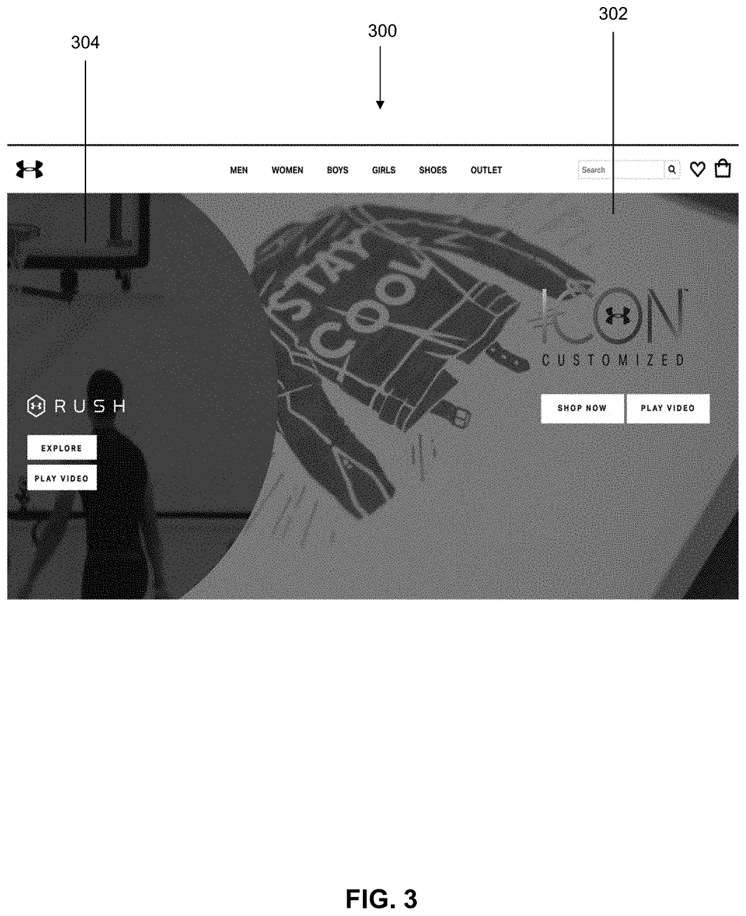

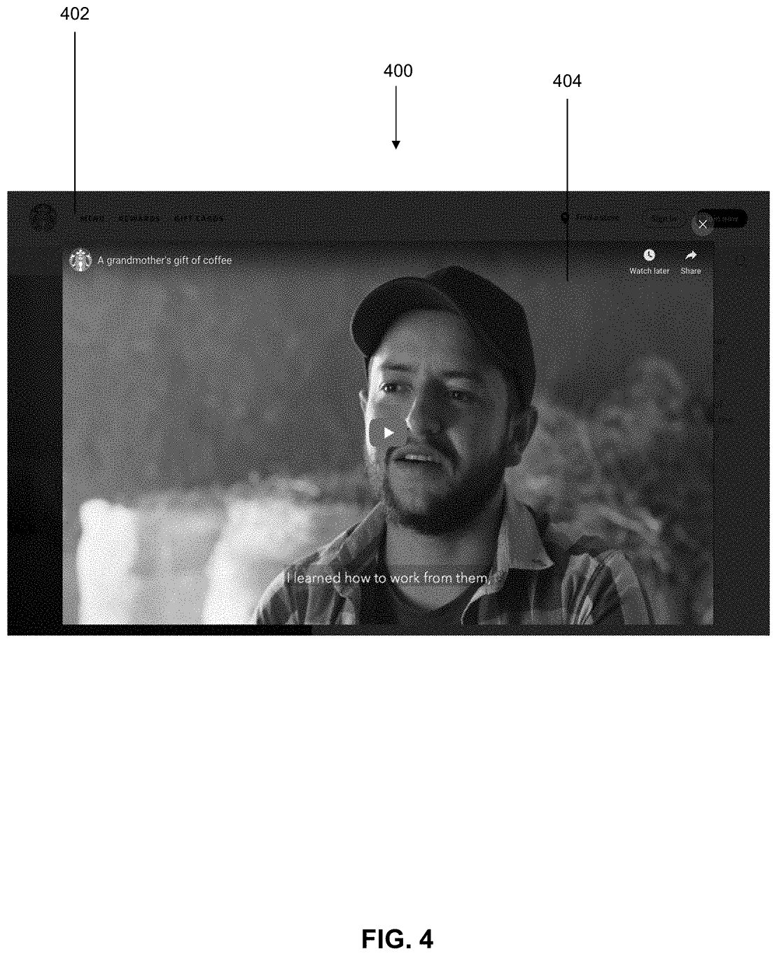

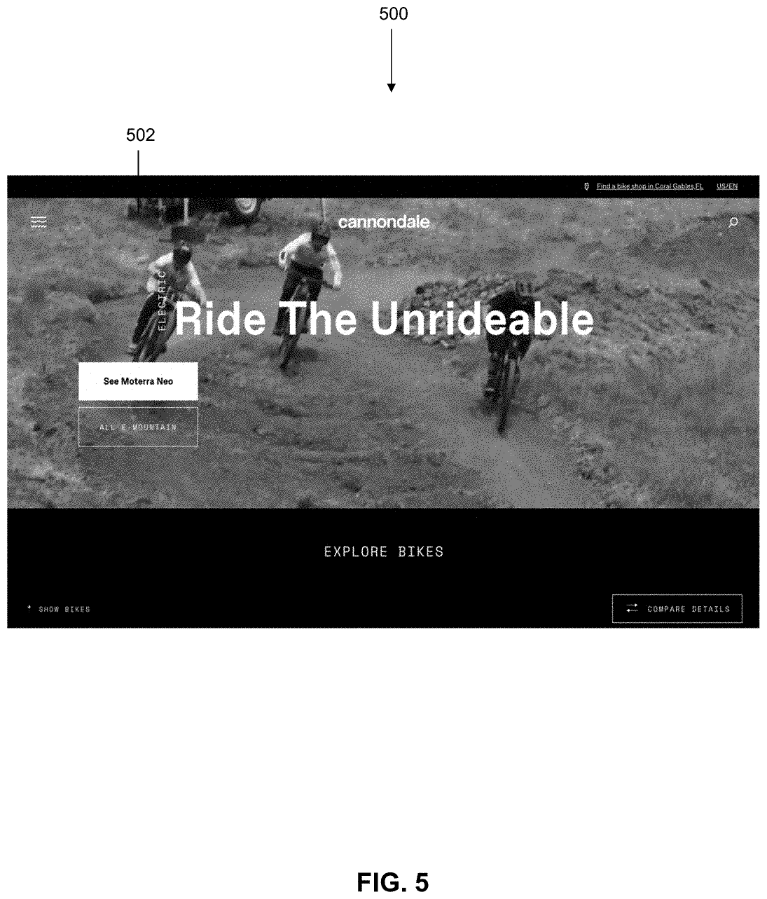

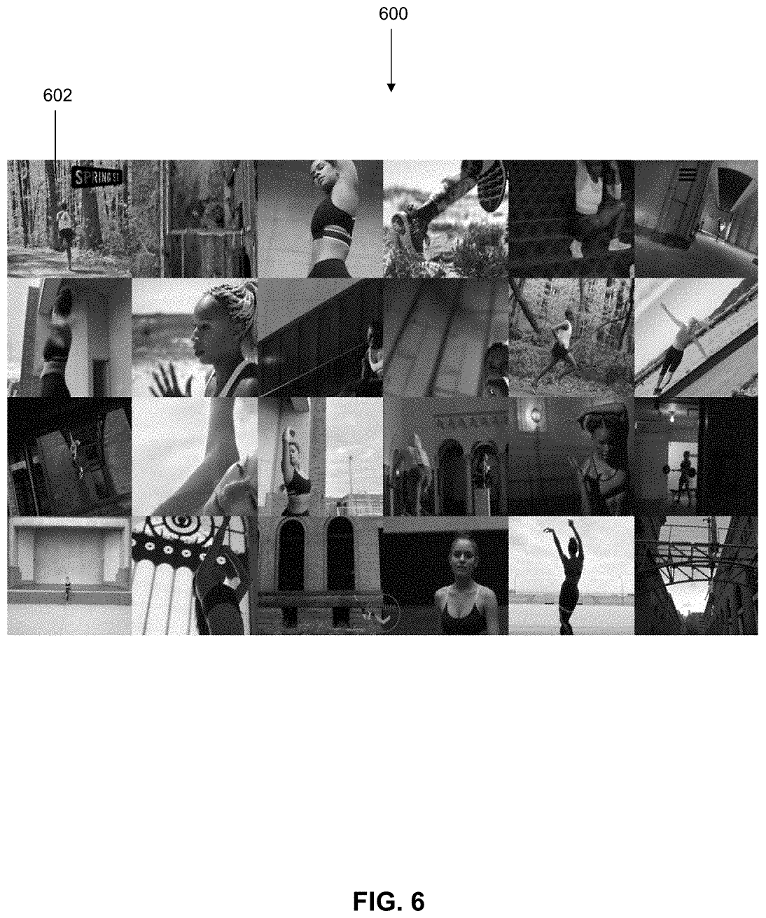

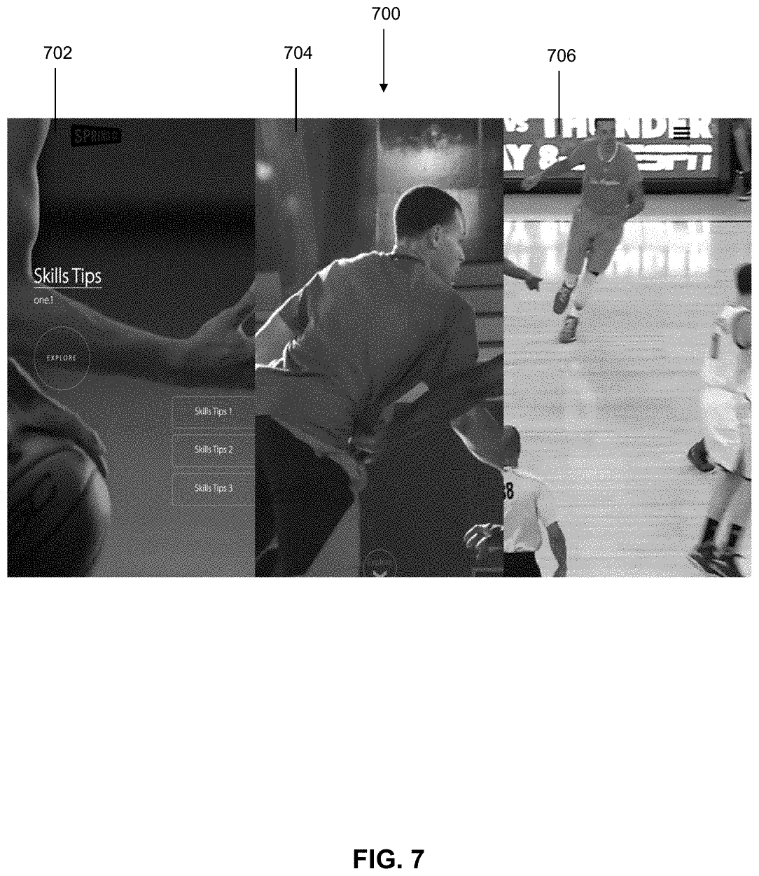

Additionally, when generating layouts for webpages of the website, the system 100 is not restricted to square and/or rectangular designs and can be custom created to any other suitable designs. For example, FIG. 3 illustrates the use of a semi-circular video feed 304 design in the screenshot of a different output 300, which has the same technical features/components as the design detailed in the example use-case scenario above, but with a different layout. The webpage output 300 may include the semi-circular video feed 304 and also a complementary video feed 302, both of which have their own controls for controlling their respective video feeds 302, 304. Referring now also to FIG. 4, an output 400 of the system 100 is illustrated. The output 400 may be a webpage including a media player 404 showing video that is embedded within the website page 402 itself. Referring now also to FIG. 5, an output 500 of the system 100 is illustrated. The output 500 may be a webpage that includes a HTML5 video tag design element 502 within a website page. Referring now also to FIG. 6, an output 600 of the system 100 is illustrated. The output 600 may be a webpage that features a multi-tile video page layout. The exemplary webpage may include 24 video tiles 602, which each include different media content for presentations to the user of the webpage. In other embodiments, any number of tiles may be utilized for a webpage featuring any number of videos or other media content. Each of the video tiles 602 may have their own controls and may play simultaneously or at any desired intervals and/or times. Referring now also to FIG. 7, an output 700 of the system 100 is illustrated. The output 700 may be a webpage featuring a multi-column layout. The exemplary webpage may include three columns with each having its own video feed 702, 704, 706 being displayed within a respective column. Each column of the webpage may have its own controls to control the video feed presented in that particular column as well.

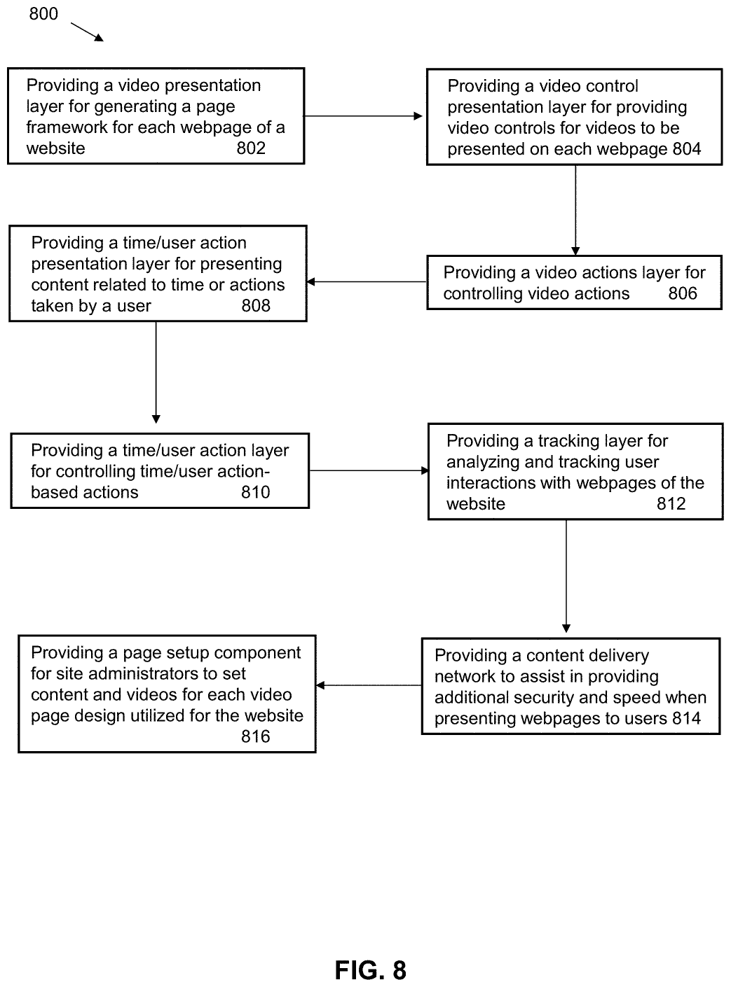

Referring now also to FIG. 8, a method 800 for providing enhanced multi-component integrated website media technology is disclosed. Notably, certain steps, such as, but not limited to steps 808-814 may be optional. Additionally, certain steps may be performed in orders that are different from shown in FIG. 8. The method 800 may include a step 802, which may include providing a video presentation layer 802 for generating a page framework for each webpage of a website (or application) for presenting media content. At step 804, the method 800 may include providing a video control presentation layer for providing video controls for media content (e.g. videos) to be presented on each webpage of the website. At step 806, the method 800 may include providing a video actions layer for controlling video actions to be conducted by a user or a device with regard to the media content being presented on the webpages of the website. At step 808, the method 800 may include a time/user action presentation layer for presenting content related to time or the specific actions taken by a user with regard to the media content. At step 810, the method 800 may include providing a time/user action layer for controlling time/user action-based actions. At step 812, the method 800 may include providing a tracking layer for tracking and analyzing user interactions with the webpages of the website. At step 814, the method 800 may include providing a content delivery network to assist in providing additional security and speed when presenting webpages to the users visiting the website. At step 816, the method 800 may include providing a page setup component for site administrators of the website to set the particular content and videos for each video page design layout utilized for the website. Notably, the method 800 may include any of the operative functionality and features of the system 100 as well.

Notably, the system 100 may include additional features and functionality. In certain embodiments, complete jQuery-based video related controls may be incorporated into a website and/or application supported by the system 100. In certain embodiments, the features of the system 10 may be built entirely on open source code with no dependence on restrictive third-party licensing. In certain embodiments, the system 100 may include multi-video control capability and a user control that can affect multiple videos on a webpage(s). In certain embodiments, the functionality provided by the system 100 may be a fully-integrated solution with no dependence on third party services or hosting. In certain embodiments, the system 100 may support cross-video control capability. For example, a time or action in one video can trigger actions on another video of the website. Notably, the technology advancements provided by the system 100 allow for the creation of a superior website visitor user experience. For example, a user can view multiple videos with a single integrated page design, where videos may be placed precisely beside each other, rather than being shown within a video frame. As another example, a user can engage with multiple videos simultaneously rather than having to open and view each video one at a time. As an additional example, the system 100 may enable website designers to custom create video overlay graphics and user control buttons to any specification and place these as desired on top of each video. In further embodiments, the system 100 may enable an integrated video page design that provides a greater interactive experience when compared to all other standard framed in video player page designs. As a result, this provides the user with a more engaging experience. Still further, the system 100 enables marketing teams to have the ability to guide site visitors through a tailored, multi-video experience based on visitor interactions and page visit or video view durations.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

We claim:

1. A system, comprising:
a memory that stores instructions; and
a processor that executes the instructions to perform operations, the operations comprising:
providing a video presentation layer that generates a page framework for each webpage of a website;
providing a video control presentation layer for providing video controls for media content presented on each webpage of the website; and
providing a video actions layer for controlling actions to be performed by a user with regard to the media content.

2. The system of claim 1, wherein the operations further comprise providing a time/user action presentation layer for presenting content related to time or the actions performed by the user.

3. The system of claim 1, wherein the operations further comprise providing a time/user action layer for controlling time/user action-based actions.

4. The system of claim 1, wherein the operations further comprise providing a tracking layer for analyzing and tracking user interactions conducted by the user with each webpage of the website.

5. The system of claim 1, wherein the operations further comprise providing a content delivery network to assist in providing security and speed when presenting each webpage on a user device of the user.

6. The system of claim 1, wherein the operations further comprise providing a page setup component for a site administrator of the website to facilitating setting of the media content for each video page of the website.

7. The system of claim 1, wherein the operations further comprise detecting a type of user device utilized by the user to access the website.

8. The system of claim 1, wherein the operations further comprise detecting a connection speed of a user device utilized by the user to access the website.

9. The system of claim 1, wherein the operations further comprise adjusting a resolution of the media content in response to detecting a type of user device utilized by the user to access the website, a connection speed of a user device utilized by the user to access the website, or a combination thereof.

10. The system of claim 1 wherein the operations further comprise adjusting a type of the media content for each webpage in response to detecting a type of user device utilized by the user to access the website, a connection speed of a user device utilized by the user to access the website, or a combination thereof.

11. The system of claim 1, wherein the operations further comprise tracking a number of plays of the media content, a pausing of the media content, a rewinding of the media content, a fast-forwarding of the media content, a stopping of the media content, any user interaction with the media content, or a combination thereof.

12. The system of claim 11, wherein the operations further comprise adjusting the media content to be presented to the user via each webpage based on the tracking.

13. A method, comprising:
providing, by utilizing instructions from a memory that are executed by a processor, a video presentation layer that generates a page framework for each webpage of a website;
providing a video control presentation layer for providing video controls for media content presented on each webpage of the website; and
providing a video actions layer for controlling actions to be performed by a user with regard to the media content.

14. The method of claim 13, further comprising optimizing delivery of the media content based on a type of user device utilized by the user to access the website, a connection speed of the user device, or a combination thereof.

15. The method of claim 13, further comprising generating a version of the media content suitable for presentation on a user device of the user upon detecting a type of the user device, a connection speed of the user device, or a combination thereof.

16. The method of claim 13, further comprising presenting a multi-column layout for a webpage of the website that features separate media content in each column of the multi-column layout.

17. The method of claim 13, further comprising presenting a multi-tile layout for a webpage of the website that features separate media content in each tile of the multi-tile layout.

18. The method of claim 13, further comprising displaying controls to the user for controlling media content on each webpage of the website, wherein the controls are adapted to a type of user device utilized by the user.

19. The method of claim 13, further comprising enabling the media content to be play looped when the user access the website.

20. A non-transitory medium comprising instructions, which, when loaded and executed by a processor, cause the processor to perform operations comprising:
providing, by utilizing instructions from a memory that are executed by a processor, a video presentation layer that generates a page framework for each webpage of a website;
providing a video control presentation layer for providing video controls for media content presented on each webpage of the website; and
providing a video actions layer for controlling actions to be performed by a user with regard to the media content.
